(19) United States
(12) Patent Application Publication
(10) Pub. No.: US 2009/0272830 A1
(43) Pub. Date: Nov. 5, 2009

(54) KITCHEN WASTES DISPOSING SYSTEM

(75) Inventor: Li Wang, Beijing (CN)

Correspondence Address: YING CHEN;Chen Yoshimura LLP, 255 S. GRAND AVE., # 215, LOS ANGELES, CA, 90012, US

(73) Assignee: BEIJING HENGYECUN S&T CO., LTD., Beijing (CN)

(21) Appl. No.: 12/120,484

(22) Filed: May 14, 2008

(30) Foreign Application Priority Data
Apr. 30, 2008 (CN) 200810105671.9

(51) Int. Cl. B02C 23/06

(52) U.S. Cl. 241/46.013

(57) ABSTRACT

The invention relates to a kitchen wastes disposing system comprising a wet solid material crusher connected on a sewer, wherein the crusher includes an automatic switch controlled by water flow in the sewer and a hand switch, wherein the two switches are connected in series, the sewer is connected with a sewage disposing system, wherein the crusher includes a shell, an upper blade set, a lower blade set and a rotating shaft, wherein the upper blade set and the lower blade set are fixed the rotating shaft and in the shell, wherein the upper blade set and the lower blade set includes a plurality of horizontal blades. The system can crush the kitchen solid waste and other similar solid wastes and send them into the sewage disposing system together with the sewage, thereby simplifying the procedure and reducing the cost or disposing solid wastes.

### BACKGROUND OF THE INVENTION

1. Field of the Invention

The invention relates to a kitchen wastes disposing system.

2. Description of the Related Art

At present, a kitchen mainly discharges such two wastes as sewage and solid waste, wherein, the sewage mainly contains organics and solid suspended substances; while the solid waste mainly comprises food residues of vegetables, grains, oil and meats, as well as a small quantity of plastic, soil, wood, sand, and so on, most of which can be decomposed by microorganisms. The sewage and solid waste are disposed separately, wherein, the sewage enters into a sewage disposing device which mainly consists of an anaerobic treatment apparatus and an aerobic treatment apparatus through the sewer pipe; while the solid waste is mixed with the city garbage to be buried or burned. As the prior burying and burning of solid wastes can cause environmental pollution and the disposing site is seriously lacked, how to disposing solid waste becomes a serious problem, so that a proper disposing method is necessary to be taken.

### SUMMARY OF THE INVENTION

In order to overcome the defects of the prior art, the invention provides a kitchen wastes disposing system which crushes the kitchen solid waste and other similar solid wastes and sending them into a sewage disposing system together with the sewage, thereby simplifying the procedure and reducing the cost or disposing solid wastes.

The technical solution of the invention for realizing the aforesaid aim is that: a kitchen wastes disposing system comprising a wet solid material crusher which is arranged on a sewer such as a sewer of a kitchen basin; the crusher is provided with an automatic switch controlled by water flow in the sewer and a hand switch. The two switches are connected in series and used to control the operation of the crusher.

As the wet solid material crusher is arranged on a sewer, the crusher is provided with an automatic switch and a hand switch which are used for controlling the water flow inside the sewer and the two switches are connected in series, when being washed into the sewer by water, the solid waste is crushed by the crusher automatically and then is sent into a sewage disposing system together with the sewage, thereby being greatly convenient for the disposing process of the kitchen solid. The solid waste and the sewage are washed into the sewage disposing system together and then are processed by the sewage disposing system, thereby not only being convenient for customer, but also ensuring good disposing effect.

### BRIEF DESCRIPTION OF THE DRAWING

FIG. 1 is a schematic view of a system according to an embodiment of the present invention.

FIG. 2 is a schematic view of a wet solid material crusher.

### DETAILED DESCRIPTION OF THE PREFERRED EMBODIMENTS

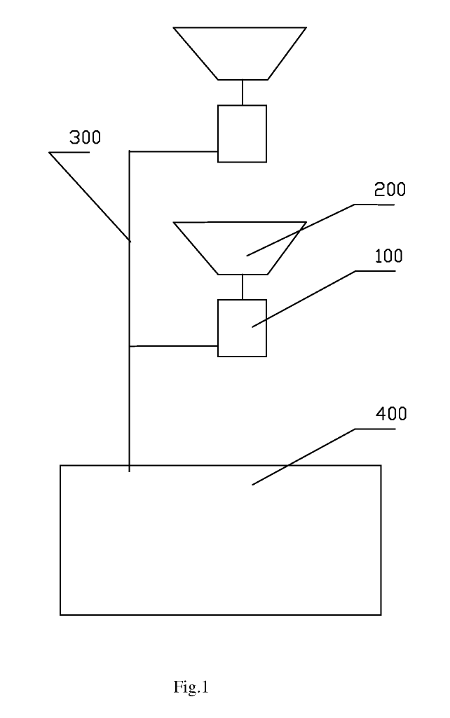

Refer to FIG. 1, the invention provides a kitchen wastes disposing system, comprising a wet solid material crusher 100. The crusher is arranged on a sewer 300 of the kitchen basin 200. The crusher is provided with an automatic switch and a hand switch which are used for controlling the operation of the crusher. The two switches are connected in series. The sewer is connected with a sewage disposing system 400. The automatic switch and the hand switch are connected with the crusher circuit through the prior art to control crusher working. The automatic switch and the connection of the automatic switch with the sewer are achieved through the prior art. The automatic switch is on when water flows through the sewer and off when no water flows through the sewer.

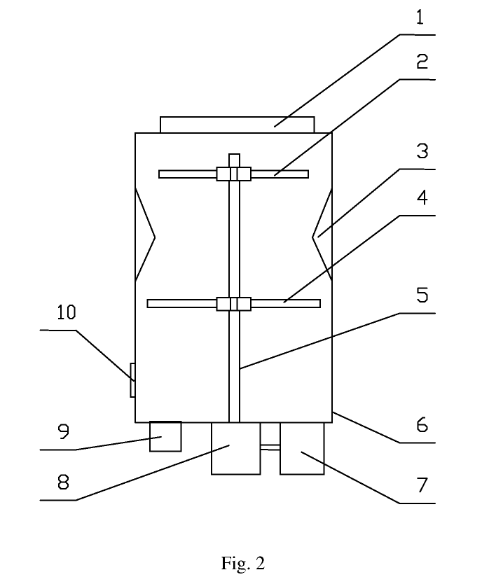

Refer to FIG. 2, the inner of the wet solid material crusher shell 6 is provided with an upper blade set 2 and a lower blade set 4, and the upper blade set and the lower blade set are fixed on the same rotating shaft 5.

Each of the upper blade set and the lower blade set includes a plurality of horizontal blades, and a certain space is kept between the upper blade set and the lower blade set so as to fully promote the functions of each blade set. The blades of the blade sets can cut up the solid material in the water under the condition of high speed rotation, thereby crushing solid waste without negative influence on the water flow.

The number of blades of the upper blade set is two to four, and that of the lower blade set is two to six. The crushing efficiency is guaranteed through the double cutting by the upper blade set and the lower blade set.

The lower end of the rotating shaft is extended from the bottom of the crusher shell and is connected with the crushing driving mechanism which comprises a crushing driving motor 7 and a crushing transmission mechanism 8 that is connected with the crushing driving motor and the rotating shaft. The rotating shaft is driven to rotate at a high speed through the crushing transmission mechanism after starting the crushing driving motor so as to drive the upper blade set and the lower blade set to rotate at a high speed.

The shell of the crusher is provided with an inlet 1 and an outlet 10. The inlet is positioned on top of the shell, and the diameter of the inlet is large enough so as to ensure that relatively large solid waste can enter into the inlet, while the outlet is positioned below the lower blade set so as to ensure the cutting for all the materials.

The section of the channel inside the crusher shell takes a round shape, thereby ensuring no cutting blind area.

A ring-shaped convex structure is arranged on the channel inside the shell between the upper blade set and the lower blade set, so that the solid material inside water can move inwards (axial direction) along the diameter direction when water flows through the ring-shaped convex structure, thereby being beneficial for the lower blade set to cut the solid waste.

The blades of the upper blade set and the lower blade set always form a certain inclined angle with the horizontal line along the tangent direction, that is, nearly take a screw propeller shape, so that water can be imposed with a downward pressure, thereby being beneficial for the smoothness of water flow.

The space between the upper blade set and the lower blade set is usually 0.5 to 2 times larger than the diameter of the channel inside the shell, thereby being beneficial for the smoothness of water flow and preventing the upper blade set and the lower blade set from influencing each other.

The switch of the crushing driving motor favors a switch which is driven by water flow so as to switching on automatically when the water flow is available and switching off automatically when having no water flow in the sewer, thereby achieving the automatic control of the crushing driving motor.

The crusher shell is also provided with a second water outlet 9, so that sewage can be discharged from the second outlet when necessary.

The invention can crush solid material which contains a large quantity of water, particularly waste with water content so as to simplify the crushing and post technology. The invention can be arranged at a proper place in kitchen such as the inlet of the sewer, so as to crush the solid material mixed in water, thereby avoiding jamming the sewer.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A kitchen wastes disposing system, comprising a wet solid material crusher connected on a sewer, wherein the crusher includes an automatic switch controlled by water flow in the sewer and a hand switch, wherein the automatic and hand switches are connected in series, and wherein the sewer is connected with a sewage disposing system.

2. The kitchen wastes disposing system according to claim 1, wherein the crusher has a shell with an inlet and an outlet, the inlet being located at a top of the shell, the outlet being located on a side wall of the shell below a lower blade set or on a bottom of the shell.

3. The kitchen wastes disposing system according to claim 2, wherein the crusher includes a shell, an upper blade set, a lower blade set and a rotating shaft, wherein the upper blade set and the lower blade set are fixed on the rotating shaft and in the shell.

4. The kitchen wastes disposing system according to claim 3, wherein the upper blade set and the lower blade set are separated by a predetermined distance.

5. The kitchen wastes disposing system according to claim 4, wherein the distance between the upper blade set and the lower blade set is 0.5 to 2 times larger than an inside diameter of the shell.

6. The kitchen wastes disposing system according to claim 2, wherein the upper blade set and the lower blade set includes a plurality of horizontal blades.

7. The kitchen wastes disposing system according to claim 6, wherein the upper blade set includes two to four blades, and the lower blade set includes two to six blades.

8. The kitchen wastes disposing system according to claim 6, wherein the blades of the upper blade set and the lower blade set form an inclined angle with a horizontal line along a tangent direction.

9. The kitchen wastes disposing system according to claim 7, wherein the blades of the upper blade set and the lower blade set form an inclined angle with a horizontal line along a tangent direction.

10. The kitchen wastes disposing system according to claim 2, wherein a lower end of the rotating shaft is extended out of the bottom of the shell of the crusher and is connected to a crushing driving mechanism, the crushing driving mechanism including a crushing driving motor and a crushing transmission mechanism which is connected with the crushing driving motor and the rotating shaft.

11. The kitchen wastes disposing system according to claim 2, wherein the shell has a round shape and a ring-shaped convex structure is arranged on the side wall of the shell between an upper blade set and a lower blade set.

12. The kitchen wastes disposing system according to claim 2, wherein the shell of the crusher has a second water outlet.

13. The kitchen wastes disposing system according to claim 5, wherein the upper blade set and the lower blade set includes a plurality of horizontal blades.

14. The kitchen wastes disposing system according to claim 13, wherein the upper blade set includes two to four blades, and the lower blade set includes two to six blades.

15. The kitchen wastes disposing system according to claim 14, wherein the blades of the upper blade set and the lower blade set form an inclined angle with a horizontal line along a tangent direction.

16. The kitchen wastes disposing system according to claim 15, wherein a lower end of the rotating shaft is extended out of the bottom of the shell of the crusher and is connected to a crushing driving mechanism, the crushing driving mechanism including a crushing driving motor and a crushing transmission mechanism which is connected with the crushing driving motor and the rotating shaft.

17. The kitchen wastes disposing system according to claim 16, wherein the shell has a round shape and a ring-shaped convex structure is arranged on the side wall of the shell between the upper blade set and the lower blade set.

18. The kitchen wastes disposing system according to claim 17, wherein the shell of the crusher has a second water outlet.
